(19) United States
(12) Patent Application Publication
(10) Pub. No.: US 2015/0162139 A1
(43) Pub. Date: Jun. 11, 2015

(54) POWER STORAGE DEVICE AND SUPER CAPACITOR DEVICE

(71) Applicant: Industrial Technology Research Institute, Hsinchu (TW)

(72) Inventors: Yu-Wei Lin, Changhua County (TW); Li-Duan Tsai, Hsinchu City (TW); Chia-Chen Fang, Taipei City (TW); Jenn-Yeu Hwang, Keelung City (TW)

(21) Appl. No.: 14/566,682

(22) Filed: Dec. 10, 2014

(30) Foreign Application Priority Data
Dec. 11, 2013 (TW) 102145619
Nov. 12, 2014 (TW) 103139209

(51) Int. Cl. H01G 11/28; H01M 4/66; H01M 4/131; H01M 4/14; H01M 4/505; H01M 4/485; H01M 10/0525; H01M 10/06; H01G 11/70; H01G 11/24; H01G 11/46; H01G 11/32; H01G 11/52; H01G 11/68; H01G 11/58; H01M 4/62

(52) U.S. Cl. CPC H01G 11/28; H01M 4/623; H01M 4/621; H01M 4/625; H01M 4/661; H01M 4/131; H01M 4/14; H01M 4/505; H01M 4/485; H01M 10/0525; H01M 10/06; H01G 11/70; H01G 11/24; H01G 11/46; H01G 11/32; H01G 11/52; H01G 11/68; H01G 11/58

(57) ABSTRACT

A power storage device includes a positive electrode and a negative electrode disposed opposite to the positive electrode. The positive electrode and the negative electrode are respectively disposed on at least one surface of a current collector foil. The positive electrode and the negative electrode respectively include an active material, a conductive auxiliary and an adhesive, wherein the active material includes a porous material, an oxidation-reduction electrode material, or combination thereof. At least one of the positive electrode and the negative electrode has a multilayer structure containing three or more layers. The concentration of the oxidation-reduction electrode material in the outmost layer of the multilayer structure is the lowest.

### CROSS-REFERENCE TO RELATED APPLICATION

This application claims the priority benefits of Taiwan application serial no. 102145619, filed on Dec. 11, 2013, and Taiwan application serial no. 103139209, filed on Nov. 12, 2014. The entirety of each of the above-mentioned patent applications is hereby incorporated by reference herein and made a part of specification.

### TECHNICAL FIELD

The technical field relates to a power storage device and a super capacitor (SC) device.

### BACKGROUND

A super capacitor (SC) is also known as an electrical double layer capacitor (EDLC) device, which stores power in the form of electrostatic energy. Studies on SC in recent years have especially focused on its high power output performance as well as energy storage and conversion capabilities. The energy storage and conversion by means of EDLC both originate from an electrical double layer structure formed by electrostatic charge adsorption. With such electrical double layer mechanism, during repeated charge/discharge operations, almost no loss of electrolytic solution and electrode caused by electrochemical reaction takes place, and thus, excellent reversible power and long-term charge/discharge cycling performance retention are achieved. The long-term cycle life may reach several tens of thousand times.

Since an area of the electrical double layer has a direct influence on electrode capacity, the commonly used electrical double layer active materials generally have characteristics such as porousness and high specific surface area. The electrical double layer active materials are not only used for active materials for capacity increase, but also used in active material supports, electronic conductors, ionic intercalation and deintercalation structures, thermal conductors or current collector substrates and so on. In addition to the active material, in order to impart to the electrode material and the current collector substrate ideal interface impedance and workability of the electrode itself, addition of an adhesive is required.

However, the adhesive itself is usually not a good conductor of electricity. Moreover, stability of the adhesive due to potential variation during charge/discharge cycles considerably affects the performance of devices in long-term cycling and capacity retention.

In past studies on SC, with the aim of improving energy density, lithium-ion battery electrode materials and electrical double layer electrode materials are often mixed together for use. However, the two different kinds of materials in the same electrode layer usually lead to competition between lithium ions so that an expected synergistic effect on function cannot be achieved. Thus, many studies began to perform coating on the two kinds of electrodes for different uses separately so as to form a double layer electrode.

Nevertheless, the aforesaid studies paid less attention to the long-term cycling characteristic and power performance.

### SUMMARY

According to an exemplary embodiment of the disclosure, a power storage device at least includes a positive electrode and a negative electrode. The positive electrode and the negative electrode are respectively disposed on at least one surface of a current collector foil. The positive electrode and the negative electrode respectively include an active material, a conductive auxiliary and an adhesive. Moreover, the active material includes a porous material, an oxidation-reduction electrode material, or combination thereof. The positive electrode and the negative electrode respectively have a multilayer structure containing three or more layers. Moreover, the oxidation-reduction electrode material in the multilayer structure has a concentration distribution along a thickness direction, and the concentration of the oxidation-reduction electrode material in an outmost layer of the multilayer structure is the lowest.

According to another exemplary embodiment of the disclosure, a super capacitor device includes an anode, a cathode, a separation membrane and an electrolytic solution. The cathode includes a positive electrode and a current collector foil; the anode includes a negative electrode and a current collector foil. The separation membrane is located between the anode and the cathode. The positive electrode and the negative electrode respectively include an active material, a conductive auxiliary and an adhesive. Moreover, the active material includes a porous material, an oxidation-reduction electrode material, or combination thereof. The positive electrode and the negative electrode respectively have a multilayer structure containing three or more layers. Moreover, the oxidation-reduction electrode material in the multilayer structure has a concentration distribution along a thickness direction, and the concentration of the oxidation-reduction electrode material in an outmost layer of the multilayer structure is the lowest.

Several exemplary embodiments accompanied with figures are described in detail below to further describe the disclosure in details.

### BRIEF DESCRIPTION OF THE DRAWINGS

FIG. 1 is a schematic cross-sectional view of a power storage device according to an exemplary embodiment of the disclosure.

FIG. 2 is a schematic cross-sectional view of a super capacitor device according to another exemplary embodiment of the disclosure.

FIG. 3 illustrates AC impedance curves of Experimental Example 1 and Comparative Examples 1 to 3.

FIG. 4 is a cyclic voltammogram of Experimental Example 1 and Comparative Example 2.

FIG. 5 is an EDS image of Experimental Example 2.

### DETAILED DESCRIPTION OF DISCLOSED EMBODIMENTS

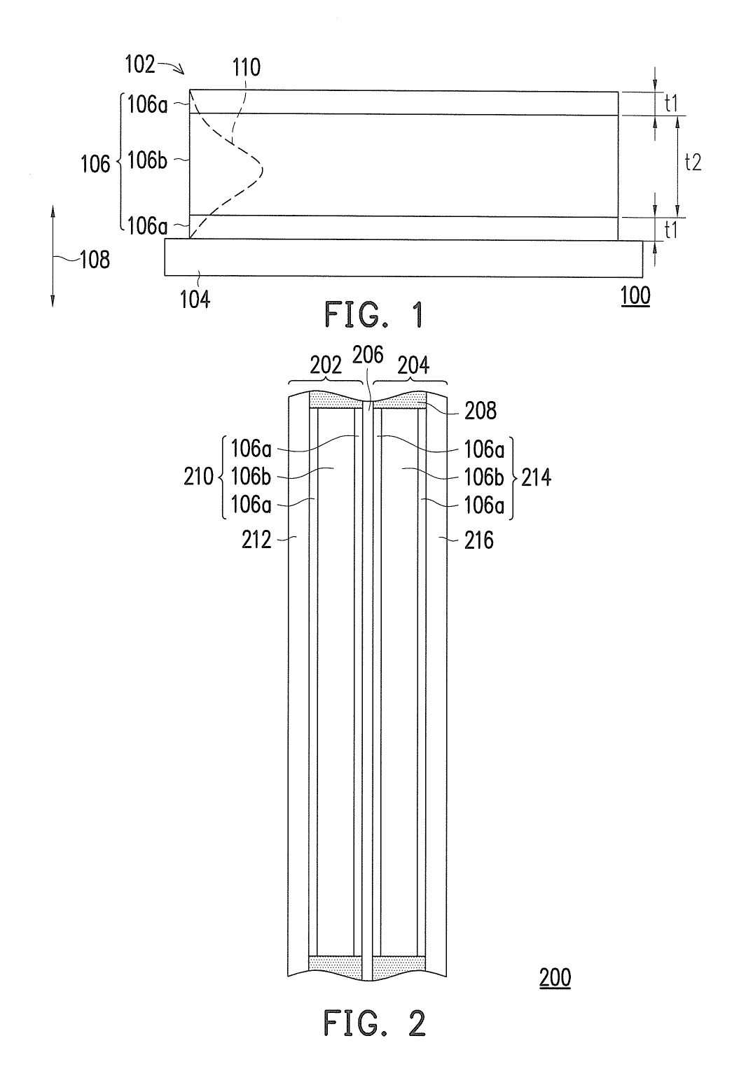

FIG. 1 is a schematic cross-sectional view of a power storage device according to an exemplary embodiment of the disclosure.

Referring to FIG. 1, a power storage device 100 of the present exemplary embodiment at least includes positive and negative electrodes 102, wherein the power storage device 100 is a lithium battery, a capacitor, a solar cell or a lead-acid battery. Moreover, other elements may be additionally disposed therein by persons of ordinary skill in the technical field of power storage according to different devices. The positive and negative electrodes 102 of the present exemplary embodiment are located on one surface of a current collector foil 104, but may also be disposed on both surfaces of the current collector foil 104. The positive and negative electrodes 102 respectively include an active material, a conductive auxiliary and an adhesive. Moreover, the active material includes a porous material, an oxidation-reduction electrode material, or combination thereof. The adhesive is, e.g., one material selected from a group consisting of polyvinylidene fluoride (PvDF), polytetrafluoroethylene (PTFE), polyvinyl alcohol (PVA), polyvinylpyrrolidone, polyethylene oxide (PEO), carboxyl methyl cellulose (CMC), styrene-butadiene rubber (SBR), polyacrylate and polyacrylonitrile. The conductive auxiliary is, e.g., one material selected from a group consisting of carbon nanotubes, carbon nanofibers, conductive graphite, graphene, carbon black and carbon nanocapsules, or a group thereof. The porous material is, e.g., one material selected from a group consisting of activated carbon, hard carbon, soft carbon, graphite, mesophasecarbon and carbon black, or a group thereof.

The oxidation-reduction electrode material in the active material is classified into an oxidation-reduction electrode material of a positive electrode and an oxidation-reduction electrode material of a negative electrode. For example, the oxidation-reduction electrode material of a positive electrode includes a lithium cobalt-based oxide, a lithium manganese-based oxide, a lithium nickel-based oxide, a lithium iron-based oxide, lithium iron salts or a group thereof. Moreover, the oxidation-reduction electrode material of a positive electrode may also be a metal oxide such as MnO₂, V₂O₅, Fe₂O₃, WO₂, NbO₂ or NbO. In addition, the oxidation-reduction electrode material of a negative electrode includes, e.g., a lithium titanium oxide, a titanium sulfide, or a group thereof. The above different kinds of oxidation-reduction electrode materials may be used solely or in combination of two or more kinds as long as they have the same polarity.

Furthermore, the positive and negative electrodes 102 have a multilayer structure 106 containing three or more layers. Although only one electrode structure is shown in FIG. 1, it should be noted that the drawing not only indicates the positive electrode or the negative electrode, but also indicates that both the positive electrode and the negative electrode have the multilayer structure 106.

The oxidation-reduction electrode material in the multilayer structure 106 has a concentration distribution 110 along a thickness direction 108. The concentration of the oxidation-reduction electrode material in an outmost layer 106a of the multilayer structure 106 is the lowest. Although the concentration distribution 110 shown in FIG. 1 is a Gaussian distribution, the disclosure is not limited hereto. The concentration distribution 110 of the oxidation-reduction electrode material may also be expressed by at least one Gaussian distribution or at least one gradient distribution.

In addition, as shown in FIG. 1 as exemplary, the multilayer structure 106 includes an intermediate layer 106b, and the outer (outmost) layers 106a on upper and lower sides of the intermediate layer 106b. In the present exemplary embodiment, a proportion of the oxidation-reduction electrode material in the outer layers 106a is, e.g., more than 0 and less than or equal to 27 wt %, and a proportion of the oxidation-reduction electrode material in the intermediate layer 106b is approximately 30 to 60 wt %. A ratio of a thickness t1 of the outer layers 106a to a thickness t2 of the intermediate layer 106b is approximately 0.1 to 0.5. When t1:t2 is 0.5 or less, an energy characteristic of the porous material in the outmost layer may be advantageously exhibited. When t1:t2 is 0.1 or more (while the outmost layer has a lower ionic resistance), a charge exchange between the oxidation-reduction material and lithium ions in the intermediate layer may be advantageously carried out, and an overall discharge behavior is determined by the intermediate layer.

The aforesaid electrode design provided by the disclosure reduces the interface impedance between components or layers in a mixed state of two different kinds of active materials, and as a result, AC impedance, DC impedance, power characteristics of the electrode as well as lifetime during long-term cyclic operation and impedance increase thus caused are all improved. The intermediate layer contains a large amount of the oxidation-reduction electrode material, which thus suppresses self-discharge of electrical double layer material and indirectly improves storage life and reduces energy loss. The outer layer that contacts the electrolytic solution contains a large amount of electrical double layer material, which thus reduces formation of a solid-electrolyte interphase (SEI) layer between a conventional oxidation-reduction material and the electrolytic solution, and indirectly reduces the cost of device activation.

FIG. 2 is a schematic cross-sectional view of a super capacitor device according to another exemplary embodiment of the disclosure, wherein elements the same as or similar to those in the previous exemplary embodiment are represented by the same reference numerals.

Referring to FIG. 2, a super capacitor device 200 of the present exemplary embodiment includes a cathode 202, an anode 204, a separation membrane 206 and an electrolytic solution 208. The cathode 202 includes a positive electrode 210 and a current collector foil 212; the anode 204 includes a negative electrode 214 and a current collector foil 216. The separation membrane 206 is located between the cathode 202 and the anode 204. Materials of the positive electrode 210 and the negative electrode 214 of the present exemplary embodiment may adopt those of the positive and negative electrodes (102) of the previous exemplary embodiment. Moreover, the positive electrode 210 and the negative electrode 214 respectively have the multilayer structure 106 containing three or more layers, the oxidation-reduction electrode material in the multilayer structure 106 has a concentration distribution along a thickness direction, and the concentration of the oxidation-reduction electrode material in the outmost layer 106a of the multilayer structure 106 is the lowest. The concentration distribution is, e.g., at least one Gaussian distribution or at least one gradient distribution. In addition, the proportion of the oxidation-reduction electrode material in the outmost layer 106a is, e.g., more than 0 and less than or equal to 27 wt %, and the proportion of the oxidation-reduction electrode material in the intermediate layer 106b is approximately 30 to 60 wt %. The thickness ratio between the outer layer 106a and the intermediate layer 106b is, e.g., 0.1 to 0.5, as mentioned in the previous exemplary embodiment. In the multilayer structure 106, the outer layer 106a that contacts the current collector foil 212 or 216 contains a smaller amount of the oxidation-reduction electrode material. Accordingly, compatibility between the outer layer 106a and the current collector foil 212 or 216 is increased, and the interface impedance is reduced so as to increase the proportion of remaining power under fast charge. The intermediate layer 106b contains a larger amount of the oxidation-reduction electrode material, and thus serves as a main energy source. In the multilayer structure 106, the outer layer 106a on the other side is a main power source.

The aforesaid electrode design proposed by the another exemplary embodiment of the super capacitor device of the disclosure reduces the interface impedance between components or layers in a mixed state of two different kinds of active materials, and as a result, AC impedance, DC impedance, power characteristics of the electrode as well as lifetime during long-teen cyclic operation and impedance increase thus caused are all improved. The intermediate layer contains a large amount of the oxidation-reduction electrode material, which thus suppresses self-discharge of electrical double layer material and indirectly improves storage life and reduces energy loss. The outer layer that contacts the electrolytic solution contains a large amount of electrical double layer material, which thus reduces formation of a solid-electrolyte interphase (SEI) layer between a conventional oxidation-reduction material and the electrolytic solution, and indirectly reduces the cost of device activation. Moreover, the electrode structure having three or more layers with different concentrations of the oxidation-reduction electrode material is prepared on the current collector foil, which accordingly improves the capacity performance of devices through variation in conductivity and energy density.

The following describes several experiments carried out in order to verify the effect of the disclosure. However, the scope of the disclosure is not limited to the following experiments.

Preparation 1

1. Materials

(1) Oxidation-reduction electrode material: lithium manganese oxide (LiMn₂O₄), abbreviated as LM.

(2) Porous material: activated carbon, abbreviated as AC.

(3) Conductive auxiliary: ECP600, ECP300, KS6, and CNT.

(4) Adhesive: carboxymethyl cellulose (CMC), sodium form.

2. An electrode was prepared on an aluminum current collector foil according to composition ratios shown in Table 1 below. Experimental Example 1 includes the first to the third layers, Comparative Example 1 includes the second to the third layers, Comparative Example 2 includes the first to the second layers, and Comparative Example 3 includes the second layer only, wherein all those layers that contact the aluminum current collector foil have a lower layer rank.

TABLE 1

| Layer | Thickness | Composition ratio (wt %) | | | | | | |
|---|---|---|---|---|---|---|---|---|
| rank | (μm) | LM | AC | CMC | ECP300 | KS6 | CNT | ECP600 |
| 1 | ≦5 | 0.1 | 19.9 | 10 | — | 47 | — | 23 |
| 2 | 40~50 | 30 | 30 | 10 | 8 | 16 | 6 | — |
| 3 | 3~10 | 0.1 | 69.9 | 10 | — | 13 | — | 7 |

Then, the electrode having a dry surface was rolled again to increase density thereof. Next, the completed electrode was sufficiently dried at 80° C. The electrode, Celgard 2320 as a separation membrane, negative lithium metal, and upper and bottom covers of the device were stacked together in a sealed inert atmosphere. Finally, sufficient electrolytic solution containing 1.3 M of LiPF₆ (EC/DEC) was injected to perform a packaging process, thereby completing preparation of a power storage device.

Test 1

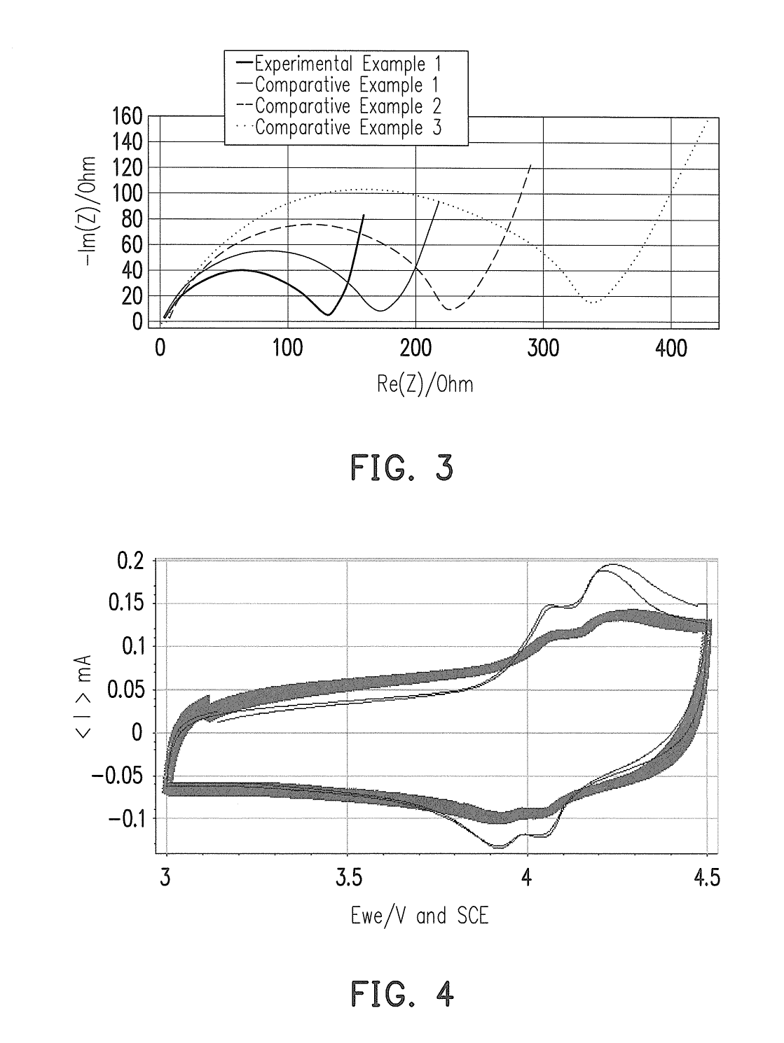

An AC impedance test was conducted on Experimental Example 1 and Comparative Examples 1 to 3, and results thereof are shown in FIG. 3. From FIG. 3, it is known that the electrode having a three-layer structure has the lowest internal resistance.

Test 2

A cyclic charge/discharge test was conducted on Experimental Example 1 and Comparative Example 2 to obtain a cyclic voltammogram as shown in FIG. 4. From the curves in FIG. 4, it is known that Experimental Example 1 (thick line segments) and Comparative Example 2 (thin line segments) had the same intercalation/deintercalation potential. Therefore, an addition of a third layer having a low concentration of the oxidation-reduction electrode material into the electrode structure does not affect intercalation/deintercalation of lithium ions.

Test 3

A high-speed charge/discharge test was conducted on Experimental Example 1 and Comparative Examples 1 to 3, and results thereof are shown in Table 2 below.

TABLE 2

| | 10 C | 20 C | 30 C | 60 C |
|---|---|---|---|---|
| Experimental Example 1 | 72% | 62% | 52% | 33% |
| Comparative Example 1 | 68% | 56% | 46% | 28% |
| Comparative Example 2 | 60% | 51% | 42% | 25% |
| Comparative Example 3 | 61% | 51% | 43% | 28% |

From Table 2, it is known that even after high-speed charge/discharge operations, the disclosure still has a higher power retention.

Preparation 2

1. Materials

(1) Oxidation-reduction electrode material: lithium titanium oxide (Li₄Ti₅O₁₂), abbreviated as LTO.

(2) Porous material: activated carbon, abbreviated as AC.

(3) Conductive auxiliary: Super P (conductive carbon black).

(4) Adhesive: polytetrafluoroethylene (PTFE).

2. An electrode was prepared on an aluminum current collector foil according to composition ratios shown in Table 3 below, wherein all of the first layers contacted the aluminum current collector foil.

TABLE 3

| | Layer | Thickness | Composition ratio (wt %) | | | |
|---|---|---|---|---|---|---|
| | rank | (μm) | PTFE | AC | LTO | Super P |
| Experimental | 1 | 25 | 5 | 80 | 10 | 5 |
| Example 2 | 2 | 50 | 5 | 60 | 30 | 5 |
| | 3 | 25 | 5 | 80 | 10 | 5 |
| Comparative | 1 | 100 | 5 | 70 | 20 | 5 |
| Example 4 | | | | | | |
| Comparative | 1 | 50 | 5 | 60 | 30 | 5 |
| Example 5 | 2 | 50 | 5 | 80 | 10 | 5 |

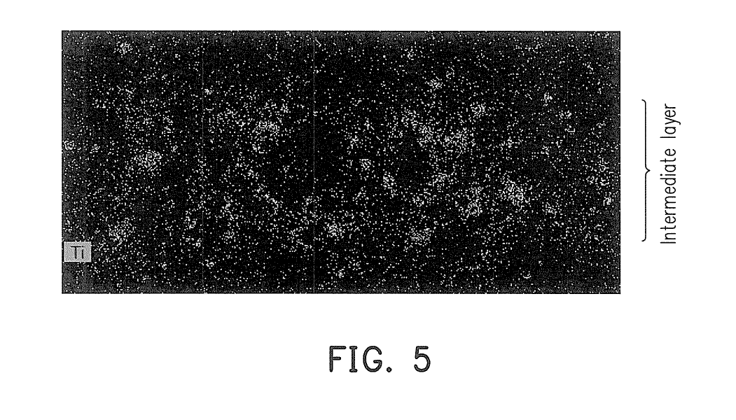

Then, the electrode structure in Experimental Example 2 was observed by EDS, as shown in FIG. 5, wherein light-colored areas indicate titanium. Thus, it is apparent that titanium and lithium are concentrated in the intermediate layer.

Next, the electrode having a dry surface was rolled again to increase density thereof. Subsequently, the completed electrode was sufficiently dried at 80° C. The electrode, Celgard 2320 as a separation membrane, positive lithium metal, and upper and bottom covers of the device were stacked together in a sealed inert atmosphere. Finally, sufficient electrolytic solution containing 1.3 M of LiPF₆ (EC/DEC) was injected to perform a packaging process, thereby completing preparation of a power storage device.

Test 4

A high-speed charge/discharge test was conducted on Experimental Example 2 and Comparative Examples 4 to 5, and results thereof are shown in Table 4 below.

TABLE 4

| | 0.2 C | 10 C | 20 C | 30 C | 60 C |
|---|---|---|---|---|---|
| Comparative Example 4 | 100.0% | 54.2% | 40.7% | 22.4% | 4.5% |
| Comparative Example 5 | 100.0% | 49.5% | 46.2% | 36.0% | 15.3% |
| Experimental Example 2 | 100.0% | 56.6% | 52.7% | 39.4% | 17.0% |

From Table 4, it is known that when the disclosure is applied to the anode, similarly, after high-speed charge/discharge operations, the disclosure still has a higher power retention.

Preparation 3

1. Materials

(1) Oxidation-reduction electrode material: lithium manganese oxide (LiMn₂O₄), abbreviated as LM.

(2) Porous material: activated carbon, abbreviated as AC.

(3) Conductive auxiliary: Super P and KS6.

(4) Adhesive: polytetrafluoroethylene (PTFE).

2. An electrode was prepared on an aluminum current collector foil according to composition ratios shown in Table 5 below. Experimental Example 3 includes the first to the third layers, Comparative Example 6 includes the second to the third layers, Comparative Example 7 includes the first to the second layers, and Comparative Example 8 includes the first layer only. All those layers that contact the aluminum current collector foil have a lower layer rank.

TABLE 5

| Layer | Thickness | Composition ratio (wt %) | | | | |
|---|---|---|---|---|---|---|
| rank | (μm) | LM | AC | PTFE | KS6 | Super P |
| 1 | 20~30 | 27 | 43 | 10 | 13.3 | 6.7 |
| 2 | 45~55 | 35 | 35 | 10 | 13.3 | 6.7 |
| 3 | 20~30 | 27 | 43 | 10 | 13.3 | 6.7 |

Then, the electrode having a dry surface was rolled again to increase density thereof. Next, the completed electrode was sufficiently dried at 80° C. The electrode, Celgard 2320 as a separation membrane, negative lithium metal, and upper and bottom covers of the device were stacked together in a sealed inert atmosphere. Finally, sufficient electrolytic solution containing 1.1 M of LiPF₆ (EC/DEC/EMC) was injected to perform a packaging process, thereby completing preparation of a power storage device.

Test 5

A high-speed charge/discharge test was conducted on Experimental Example 3 and Comparative Examples 6 to 8, and results thereof are shown in Table 6 below.

TABLE 6

| | 0.2 C | 10 C | 20 C | 30 C | 60 C | 120 C |
|---|---|---|---|---|---|---|
| Experimental | 100.0% | 84.5% | 72.1% | 56.4% | 31.0% | 13.7% |
| Example 3 | | | | | | |
| Comparative | 100.0% | 83.4% | 69.4% | 53.1% | 27.0% | 9.6% |
| Example 6 | | | | | | |
| Comparative | 100.0% | 82.5% | 66.1% | 49.5% | 25.1% | 9.3% |
| Example 7 | | | | | | |
| Comparative | 100.0% | 81.9% | 66.3% | 50.4% | 25.2% | 9.4% |
| Example 8 | | | | | | |

From Table 6, it is known that even after high-speed charge/discharge operations, the disclosure still has a higher power retention.

In summary, the electrode structure of the disclosure is an electrode structure prepared on a current collector foil and having three or more layers with different concentrations of the oxidation-reduction electrode material. Thus, by making the concentration of the oxidation-reduction electrode material on the outmost side the lowest, and making the concentration of the oxidation-reduction electrode material show a concentration distribution in the multilayer electrode structure, the capacity performance of devices may be improved.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A power storage device, at least comprising:
a positive electrode; and
a negative electrode disposed opposite to the positive electrode, wherein
the positive electrode and the negative electrode are respectively disposed on at least one surface of a current collector foil,
the positive electrode and the negative electrode respectively comprise an active material, a conductive auxiliary and an adhesive, and
the active material comprises a porous material, an oxidation-reduction electrode material, or combination thereof,
at least one of the positive electrode and the negative electrode has a multilayer structure containing three or more layers, wherein the oxidation-reduction electrode material in the multilayer structure has a concentration distribution along a thickness direction, and a concentration of the oxidation-reduction electrode material in an outmost layer of the multilayer structure is the lowest.

2. The power storage device according to claim 1, wherein the concentration distribution comprises at least one Gaussian distribution or at least one gradient distribution.

3. The power storage device according to claim 1, wherein the oxidation-reduction electrode material of the positive electrode comprises a lithium cobalt-based oxide, a lithium manganese-based oxide, a lithium nickel-based oxide, a lithium iron-based oxide, lithium iron salts or a group thereof.

4. The power storage device according to claim 1, wherein the oxidation-reduction electrode material of the positive electrode comprises a metal oxide.

5. The power storage device according to claim 4, wherein the metal oxide comprises MnO₂, V₂O₅, Fe₂O₃, WO₂, NbO₂ or NbO.

6. The power storage device according to claim 1, wherein the oxidation-reduction electrode material of the negative electrode comprises a lithium titanium oxide, a titanium sulfide, or a group thereof.

7. The power storage device according to claim 1, wherein the porous material is one material selected from a group consisting of activated carbon, hard carbon, soft carbon, graphite, mesophasecarbon and carbon black, or a group thereof.

8. The power storage device according to claim 1, wherein the conductive auxiliary is one material selected from a group consisting of carbon nanotubes, carbon nanofibers, conductive graphite, graphene, carbon black and carbon nanocapsules, or a group thereof.

9. The power storage device according to claim 1, wherein the adhesive is one material selected from a group consisting of polyvinylidene fluoride (PvDF), polytetrafluoroethylene (PTFE), polyvinyl alcohol (PVA), polyvinylpyrrolidone, polyethylene oxide (PEO), carboxyl methyl cellulose (CMC), styrene-butadiene rubber (SBR), polyacrylate and polyacrylonitrile.

10. The power storage device according to claim 1, wherein the multilayer structure consists of an intermediate layer, and outer layers on upper and lower sides of the intermediate layer.

11. The power storage device according to claim 10, wherein a proportion of the oxidation-reduction electrode material in the outer layers is from more than 0 to 27 wt %, and a proportion of the oxidation-reduction electrode material in the intermediate layer is 30 to 60 wt %.

12. The power storage device according to claim 10, wherein a thickness ratio of the outer layer to the intermediate layer is 0.1 to 0.5.

13. The power storage device according to claim 1, wherein the power storage device comprises a lithium battery, a capacitor, a solar cell or a lead-acid battery.

14. A super capacitor device, comprising:
a cathode, comprising a positive electrode and a current collector foil;
an anode, comprising a negative electrode and a current collector foil;
a separation membrane located between the anode and the cathode; and
an electrolytic solution, wherein
the positive electrode and the negative electrode respectively comprise an active material, a conductive auxiliary and an adhesive, and
the active material comprises a porous material, an oxidation-reduction electrode material, or combination thereof,
the positive electrode and the negative electrode respectively have a multilayer structure containing three or more layers, wherein the oxidation-reduction electrode material in the multilayer structure has a concentration distribution along a thickness direction, and a concentration of the oxidation-reduction electrode material in an outmost layer of the multilayer structure is the lowest.

15. The super capacitor device according to claim 14, wherein the concentration distribution comprises at least one Gaussian distribution or at least one gradient distribution.

16. The super capacitor device according to claim 14, wherein the oxidation-reduction electrode material of the positive electrode comprises a lithium cobalt-based oxide, a lithium manganese-based oxide, a lithium nickel-based oxide, a lithium iron-based oxide, lithium iron salts or a group thereof.

17. The super capacitor device according to claim 14, wherein the oxidation-reduction electrode material of the positive electrode comprises a metal oxide.

18. The super capacitor device according to claim 17, wherein the metal oxide comprises MnO₂, V₂O₁₈, Fe₂O₃, WO₂, NbO₂ or NbO.

19. The super capacitor device according to claim 14, wherein the oxidation-reduction electrode material of the negative electrode comprises a lithium titanium oxide, a titanium sulfide, or a group thereof.

20. The super capacitor device according to claim 14, wherein the porous material is one material selected from a group consisting of activated carbon, hard carbon, soft carbon, graphite, mesophasecarbon and carbon black, or a group thereof.

21. The super capacitor device according to claim 14, wherein the conductive auxiliary is one material selected from a group consisting of carbon nanotubes, carbon nanofibers, conductive graphite, graphene, carbon black and carbon nanocapsules, or a group thereof.

22. The super capacitor device according to claim 14, wherein the adhesive is one material selected from a group consisting of polyvinylidene fluoride (PvDF), polytetrafluoroethylene (PTFE), polyvinyl alcohol (PVA), polyvinylpyrrolidone, polyethylene oxide (PEO), carboxyl methyl cellulose (CMC), styrene-butadiene rubber (SBR), polyacrylate and polyacrylonitrile.

23. The super capacitor device according to claim 14, wherein the multilayer structure consists of an intermediate layer and outer layers on upper and lower sides of the intermediate layer.

24. The super capacitor device according to claim 23, wherein a proportion of the oxidation-reduction electrode material in the outer layers is from more than 0 to 27 wt %, and a proportion of the oxidation-reduction electrode material in the intermediate layer is 30 to 60 wt %.

25. The super capacitor device according to claim 23, wherein a thickness ratio of the outer layer to the intermediate layer is 0.1 to 0.5.
